(19) United States
(12) Patent Application Publication
(10) Pub. No.: US 2016/0121351 A1
(43) Pub. Date: May 5, 2016

(54) DOUBLE ACTING BLADDER PUMP

(71) Applicant: GOJO Industries, Inc., Akron, OH (US)

(72) Inventors: Nick E. Ciavarella, Seven Hills, OH (US); Emily B. Kennedy, Cleveland, OH (US)

(21) Appl. No.: 14/929,581

(22) Filed: Nov. 2, 2015

Related U.S. Application Data
(60) Provisional application No. 62/075,086, filed on Nov. 4, 2014.

(51) Int. Cl. B05B 11/00; F04B 53/10; A47K 5/12; F04B 53/16; F04B 45/04; F04B 43/02; F04B 53/14

(52) U.S. Cl. CPC B05B 11/3066; F04B 43/026; F04B 53/10; F04B 53/14; F04B 53/16; F04B 45/043; B05B 11/3052; A47K 5/12

(57) ABSTRACT

An exemplary refill unit includes a container and a pump secured to the container. The pump includes a liquid inlet, a first chamber, a second chamber, a liquid inlet valve, a liquid outlet valve; and an outlet. The liquid inlet valve has a first sealing member that allows fluid to flow into the first chamber and a second sealing member that allows fluid to flow into the second chamber and prevents fluid from flowing out of the first chamber back into the container. The liquid outlet valve has a first sealing member that allows fluid to flow out of the first chamber and through the liquid outlet and a second sealing member that allows fluid to flow out of the second chamber and through the liquid outlet.

### RELATED APPLICATIONS

This application claims priority to and the benefits of U.S. Provisional Patent Application Ser. No. 62/075,086 filed on Nov. 4, 2014, entitled “DOUBLE ACTING BLADDER PUMP,” which is incorporated herein by reference in its entirety.

### TECHNICAL FIELD

The present invention relates generally to liquid dispenser systems, such as liquid soap and sanitizer dispensers.

### BACKGROUND OF THE INVENTION

Liquid dispensing systems, such as liquid soap and sanitizer dispensers, provide a user with a predetermined amount of liquid or foam upon actuation of the dispenser.

### SUMMARY

Exemplary embodiments of dispensers, refill units and pumps with two-chamber double acting pumps and refill units are herein.

An exemplary refill unit includes a container and a pump secured to the container. The pump includes a liquid inlet, a first chamber, a second chamber, a liquid inlet valve, a liquid outlet valve; and an outlet. The liquid inlet valve has a first sealing member that allows fluid to flow into the first chamber and a second sealing member that allows fluid to flow into the second chamber and prevents fluid from flowing out of the first chamber back into the container. The liquid outlet valve has a first sealing member that allows fluid to flow out of the first chamber and through the liquid outlet and a second sealing member that allows fluid to flow out of the second chamber and through the liquid outlet.

Another exemplary refill unit includes a container and a pump secured to the container. The pump has a first pumping chamber and a second pumping chamber. The first pumping chamber includes a first liquid inlet valve to the first pump chamber and a first liquid outlet valve from the first pump chamber. The second pumping chamber includes a second liquid inlet valve to the second pump chamber and a second liquid outlet valve from the second pump chamber. The pump also includes an outlet. The first pump chamber, the first liquid inlet valve, the first liquid outlet valve, the second pump chamber, the second liquid inlet valve and the second liquid outlet valve are formed by a unitary elastomeric member.

Another exemplary refill unit includes a container and a pump connected to the container. The pump has a liquid inlet and a liquid outlet. In addition, the pump has an elastomeric dome. The elastomeric dome forms a first pump chamber and a second pump chamber located between the liquid inlet and the liquid outlet. A liquid inlet valve is included. The liquid inlet valve includes a first liquid inlet sealing member for allowing fluid to flow from the liquid inlet to the first pump chamber when the first pump chamber has a negative pressure and prevents fluid from flowing from the first pump chamber into the liquid inlet when there is a positive pressure in the first pump chamber and a second liquid inlet sealing member for allowing fluid to flow from the liquid inlet to the second pump chamber when the second pump chamber has a negative pressure and prevents fluid from flowing from the second pump chamber into the liquid inlet when there is a positive pressure in the second pump chamber.

Yet another exemplary refill unit includes a container and a pump secured to the container. The pump includes a first pumping portion having a first liquid pump and a first air pump and a second pump portion having a second liquid pump and a second air pump. The first pump portion is activated by applying a force in a first direction and the second pump portion is activated by applying force in a second direction that is different than the first direction.

### BRIEF DESCRIPTION OF THE DRAWINGS

These and other features and advantages of the present invention will become better understood with regard to the following description and accompanying drawings in which:

FIG. 1 is a cross-section of an exemplary dispenser having a refill unit;

FIG. 2 is a cross-section of the exemplary dispenser and refill unit of FIG. 1;

FIG. 3 is a cross-section of an exemplary refill unit;

FIG. 3A is a cross-section of a refill unit and an exemplary actuator (with some parts removed for clarity) of FIG. 3 along line 3A;

FIG. 4A is a cross-section of the refill unit of FIG. 3 with the right side diaphragm in an discharged position;

FIG. 4B is a cross-section of the refill unit of FIG. 3 with the right side diaphragm transitioning from a discharged to charged or primed state and the left side diaphragm in a discharged position;

FIG. 4C is a cross-section of the refill unit of FIG. 3 with the right side diaphragm in a discharged position and the left side diaphragm transitioning from a discharged to charged or primed state;

FIG. 4D is a cross-section of the refill unit of FIG. 3 with the left and right side diaphragms in a discharged position;

FIG. 4E is a cross-section of the refill unit of FIG. 3 with the left and right side diaphragms transitioning from a discharged to charged or primed state;

FIG. 5 is a cross-section of another exemplary refill unit;

FIG. 6A is a cross-section of the refill unit of FIG. 5 with the right side diaphragm in a discharged position;

FIG. 6B is a cross-section of the refill unit of FIG. 5 with the right side diaphragm transitioning from a discharged to charged or primed state and the left side diaphragm in a discharged position;

FIG. 6C is a cross-section of the refill unit of FIG. 5 with the right side diaphragm in a discharged position and the left side diaphragm transitioning from a discharged to charged or primed state;

FIG. 6D is a cross-section of the refill unit of FIG. 5 with the left and right side diaphragms in a discharged position;

FIG. 6E is a cross-section of the refill unit of FIG. 5 with the left and right side diaphragms transitioning from a discharged to charged or primed state;

FIG. 7 is a cross-section of another exemplary refill unit; and

FIG. 7A is an enlarged view of a portion of FIG. 7.

### DETAILED DESCRIPTION

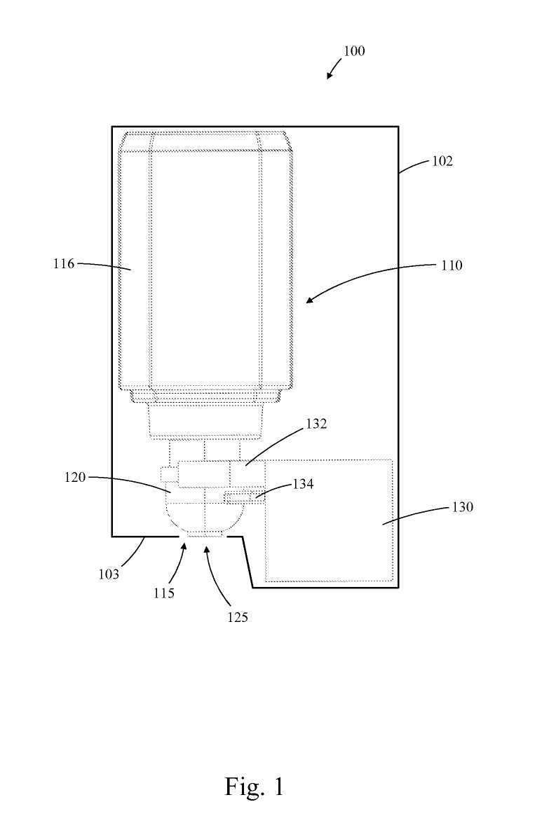

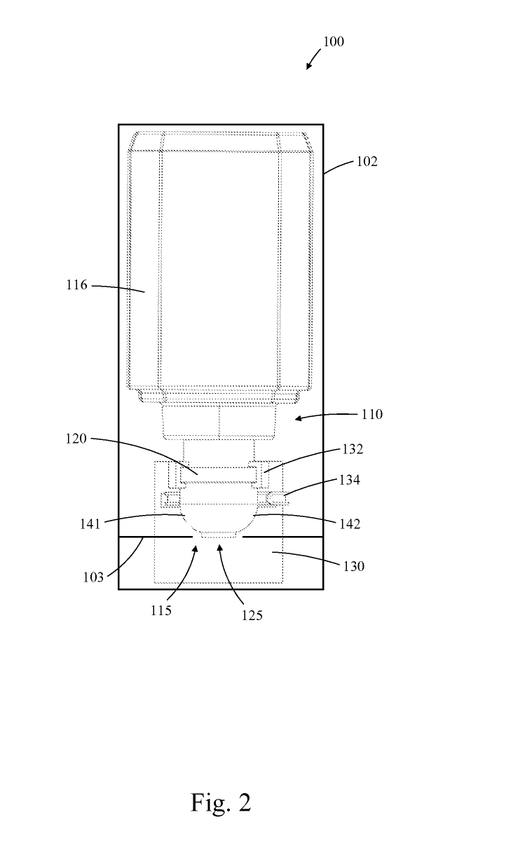

FIGS. 1 and 2 illustrate an exemplary embodiment of a foam dispenser 100. The cross-section of FIG. 1 is taken through housing 102 to show pump 120 and container 116. The cross-section of FIG. 2 is also taken through housing 102, but from the front to more clearly indicate the position of some components of dispenser 100. Liquid dispenser 100 includes a disposable refill unit 110. Disposable refill unit 110 includes a container 116 connected to a pump 120. Dispenser 100 may be a wall-mounted system, a counter-mounted system, an un-mounted portable system movable from place to place, or any other kind of dispenser system.

Container 116 forms a liquid reservoir that contains a supply of dispensable liquid within the disposable refill unit 110. In various embodiments, the contained liquid could be for example a soap, a sanitizer, a cleanser, a disinfectant, a foamable liquid, or some other dispensable liquid. In the exemplary disposable refill unit 110, container 116 is a collapsible container and can be made of thin plastic or a flexible bag-like material. In other embodiments, container 116 may be formed by a rigid housing member, or have any other suitable configuration for containing the liquid without leaking A rigid container may include a vent (not shown) to vent the container. Container 116 may advantageously be refillable, replaceable or both refillable and replaceable.

In the event the liquid stored in container 116 of the installed disposable refill unit 110 runs out, or the installed refill unit 110 otherwise has a failure, the installed refill unit 110 may be removed from dispenser 100. The empty or failed disposable refill unit 110 may then be replaced with a new disposable refill unit 110.

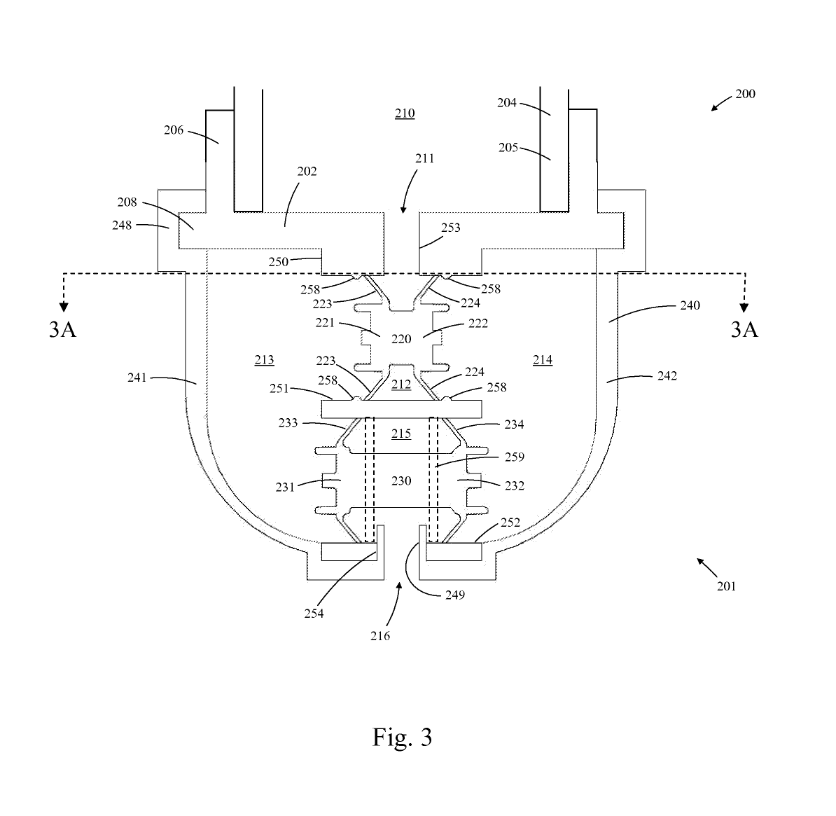

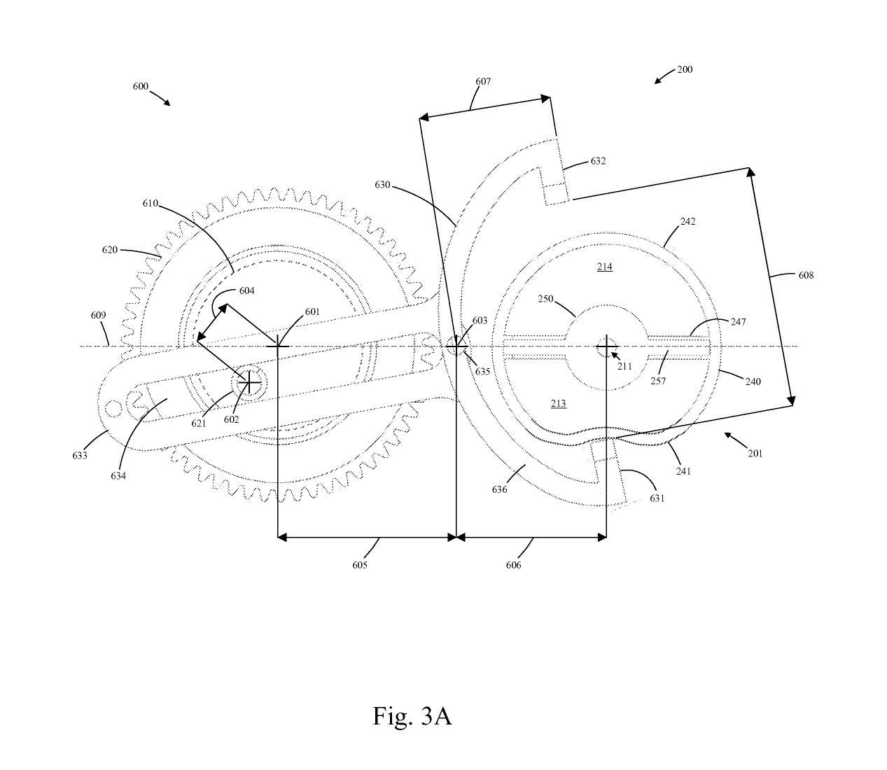

Dispenser 100 contains one or more actuating members 134 driven by one or more actuators 130 to activate pump 120. As used herein, actuator or actuating members or mechanism includes one or more parts that cause the dispenser 100 to move liquid, air or foam. Actuator 130 is generically illustrated because there are many different kinds of pump actuators which may be employed in dispenser 100. Actuator 130 of dispenser 100 may be any type of actuator, such as a manual lever, a manual pull bar, a manual push bar, a manual rotatable crank, an electrically activated actuator or other means for actuating pump 120, which includes a liquid pump portion and may also include an air pump portion. Electronic actuators may additionally include a sensor (not shown) to provide for a hands-free dispenser system with touchless operation. In one embodiment, actuating member 134 comprises an actuating arm 630 (FIG. 3A) with two opposing ends 631 and 632 (FIG. 3A) that directly engage left chamber 141 and right chamber 142 of pump 120, respectively. In other embodiments, intermediate linkages or members may be included between actuating members 134 and pump 120, or actuator 130 may directly actuate pump 120 without the use of any intermediate members. In the illustrated embodiment, actuator 130 is connected to housing 102 of liquid dispenser 100. Actuator 130 may be connected to housing 102 by any means, such as a threaded connection, a welded connection, an adhesive connection, or the like. In one embodiment, actuator 130 includes a base member 132 that holds disposable refill unit 110 such that actuating members 134 can engage pump 120 on refill unit 110. In other embodiments base member 132 is connected to housing 102. An aperture 115 in bottom plate 103 of housing 102 allows liquid dispensed from the nozzle 125 of pump 120 to be dispensed to a user.

FIG. 3 is a cross-sectional view of an exemplary embodiment of a refill unit 200 suitable for use in liquid dispensers. Refill unit 200 includes a container 204 connected to a pump 201. The interior of container 204 forms a reservoir 210 for holding dispensable liquid. Pump 201 includes a housing 202 with an annular projection 206. A neck 205 of container 204 is received within annular projection 206. Housing 202 may be connected to the container 204 by any means, such as a threaded connection, a welded connection, an adhesive connection, a snap fit connection, a friction fit connection, or the like. Optionally, a gasket may fit between neck 205 and housing 202 to help form a liquid tight seal with the container 204.

Pump housing 202 further includes a valve housing 250 configured to hold multidirectional inlet valve 220 and multidirectional outlet valve 230. In some embodiments, valve housing 250 is integrally part of housing 202. Valve housing 250 includes one or more inlet valve housing portions 251 and one or more outlet valve housing portions 252. One or more inlet holes 253 fluidly connect the inlet valve housing 251 to reservoir 210, forming an inlet passageway 211. One or more outlet apertures 254 fluidly connect outlet valve housing portion 252 to the environment, forming an outlet nozzle 216. Valve housing 250 further includes a chamber wall 257 (FIG. 3A).

Pump 201 includes a diaphragm 240 that sealably connects with housing 202, valve housing 250, and chamber wall 257, forming a left pump chamber 213 and a right pump chamber 214. In some embodiments, diaphragm 240 includes an annular groove 248 for receiving a rim 208 on housing 202 to form a liquid tight connection between diaphragm 240 and housing 202. Diaphragm 240 also includes an interior sealing groove 247 (FIG. 3A) for receiving chamber wall 257 (FIG. 3A) to form a liquid tight connection between diaphragm 240 and chamber wall 257, thereby preventing leakage between the left and right pump chambers 213, 214. Diaphragm 240 may be connected to housing 202, valve housing 250, and chamber wall 257 by any means, such as a welded connection, an adhesive connection, or the like. Diaphragm 240 may be formed from any elastomeric material, such as an elastomeric material having a Shore A hardness of 20-70, including, but not limited to, silicone, polyurethane, vinyl, TPE, TPV, TPR, or rubber.

Inlet valve housing portion 251 forms an inlet valve chamber 212 that is in fluid communication with inlet passageway 211 and both the left and right pump chambers 213, 214. Inlet valve unit 220 is disposed within inlet valve housing 251. Inlet valve unit 220 comprises a left inlet valve portion 221 and a right inlet valve portion 222. In some embodiments, as shown in FIG. 3, left and right inlet valve portions 221, 222 are formed as a single part and are held in place within inlet valve housing 251 by an annular ridges 258. Left inlet valve portion 221 is a one-way valve that is oriented such that it allows flow into, and prevents flow out of, left pump chamber 213. Right inlet valve portion 222 is a one-way valve that is oriented such that it allows flow into, and prevents flow out of, right pump chamber 214.

Left and right inlet valve portions 221, 222 each include annular flexible sealing members 223, 224 that form a liquid tight seal against the inlet valve housing portion 251. Flexible sealing members 223, 224 are conical in shape and are rigid enough to form a seal with inlet valve housing 251 in a resting state. Flexible sealing members 223, 224 are flexible enough that they will bend toward left and right pump chambers 213, 214, respectively, when the fluid pressure is lower in the pump chambers 213, 214 than it is in inlet valve chamber 212, thereby allowing liquid to flow from inlet valve chamber 212 and into left or right pump chambers 213, 214. Left and right inlet valve portions 221, 222 are annular wiper valves in some embodiments, but can be any kind of one-way valves, such as a ball and spring valves, poppet valves, flapper valves, umbrella valves, slit valves, mushroom valves, duck bill valves, or the like.

Outlet valve housing portion 252 forms an outlet valve chamber 215 that is in fluid communication with outlet nozzle 216 and both left and right pump chambers 213, 214. Outlet valve unit 230 is disposed within outlet valve housing portion 252. Outlet valve unit 230 comprises a left outlet valve portion 231 and a right outlet valve portion 232. In some embodiments, as shown in FIG. 3, left and right outlet valve portions 231, 232 are formed as a single part and are held in place within outlet valve housing 252 by supports 259 that may be integrally formed with outlet valve unit 230. Left outlet valve portion 231 is a one-way valve that is oriented such that it allows flow out of, and prevents flow into, left pump chamber 213. Right outlet valve portion 232 is a one-way valve that is oriented such that it allows flow out of, and prevents flow into, right pump chamber 214.

Left and right outlet valve portions 231, 232 each include annular flexible sealing members 233, 234 that form a liquid tight seal against the outlet valve housing 252. Flexible sealing members 233, 234 are conical in shape and are rigid enough to form a seal with the outlet valve housing 252 in a resting state. Flexible sealing members 233, 234 are flexible enough that they will bend toward outlet valve chamber 215 when the fluid pressure is higher in the left and right pump chambers 213, 214 than it is in outlet valve chamber 215, thereby allowing liquid to flow from the left and right pump chambers 213, 214 and into outlet valve chamber 215. Left and right outlet valve portions 221, 222 are annular wiper valves in some embodiments, but can be any kind of one-way valves, such as a ball and spring valves, poppet valves, flapper valves, umbrella valves, slit valves, mushroom valves, duck bill valves, or the like.

Pump 201 is actuated by applying force to the left side 241 or right side 242 of diaphragm 240. Applying force to the left side 241 of diaphragm 240 actuates left pump chamber 213, and applying force to the right side 241 of diaphragm 240 actuates right pump chamber 214. In either case, the volume of pump chamber 213, 214 is reduced by application of force to diaphragm 240, moving diaphragm 240 from a charged or primed state to a discharged state. This reduction in volume causes the fluid inside the pump chambers 213, 214 to increase in pressure thereby causing outlet valves 231, 232 to open, releasing fluid from pump chambers 213, 214. When the actuating force is removed, the left or right sides 241, 242 of diaphragm 240 return to their charged position because of the elastic properties of diaphragm 240. The volume of pump chambers 213, 214 increases as diaphragm 240 elastically recovers, causing the pressure in the pump chambers 213, 214 to drop. The dropping pressure in the pump chambers 213, 214 causes outlet valves 231, 231 to close and inlet valves 221, 222 to open, allowing fluid to flow into pump chambers 213, 214, thereby priming pump 201.

FIG. 3A illustrates a cross-sectional view of the exemplary refill unit 200 of FIG. 3 taken along the line 3A, including an actuator 600. Actuator 600 includes a motor 610, a drive wheel 620, and an actuation member 630. Motor 610 is an electric motor and shares an axis of rotation 601 with drive wheel 620. In some embodiments, drive wheel 620 and motor 610 do not share a rotational axis and motor 610 turns drive wheel 620 through any other means, such as gears or belts, or the like.

Drive wheel 620 includes a post 621 with a post axis 602. The distance between post axis 621 and axis of rotation 601 is post radius 604. Post 621 may be attached to drive wheel 620 in any way, such as with a threaded connection, a welded connection, an adhesive connection, or the like. Post 621 may be fixed or may rotate around post axis 602. Actuation member 630 includes a drive arm 633, a fork 636, and a pivot 635. Drive arm 633 includes a slot 634 that slideably interacts with post 621. Fork 636 of actuation member 630 ends in a left end 631 and a right end 632.

During operation, motor 610 turns drive wheel 620 causing post 621 to orbit around axis of rotation 601 and slide back and forth within slot 634, translating the rotational motion of the motor 610 to an arcuate reciprocating motion. This motion causes actuation member 630 to pivot back and forth about pivot axis 603, thereby causing the left and right ends 631, 632 of fork 636 to alternatively apply force to the left and right sides 241, 242 of diaphragm 240, actuating pump 201.

The period of actuation of actuator 600 can be adjusted by changing the rotational speed of motor 610, or by using gears or other mechanical means to vary the rotational speed of drive wheel 620 relative to the speed of motor 610. The distance that actuation member 630 travels during actuation, or stroke, can be adjusted by varying post radius 604 and the distance 605 between axis of rotation 601 and pivot 603 of actuation member 630. Varying the distance between left and right ends 631, 632 of fork 636 will also change the stroke of the actuator. The location where ends 631 and 632 engage diaphragm 240 of pump 201 can be adjusted by varying the distance between ends 631, 632 and pivot 603, or by moving pump 201 relative to actuator 600 to change distance 606.

During operation, each end 631, 632 of fork 636 of actuation member 630 goes through two full strokes. During the actuation stroke, the ends 631, 632 of fork 636 alternately engage diaphragm 240 of pump 201 and push it inward to actuate chambers 213, 214 of pump 201, alternately discharging left chamber 213 and right chamber 214 of pump 201. During the recovery stroke, the ends 631, 632 of fork 636 move in the opposite direction to release diaphragm 241, 242 from its actuated state. Because diaphragm 241, 242 is made of a material that deforms elastically, elastic potential energy is built up in diaphragm 241, 242 during the actuation stroke and is released during the recovery stroke. As this energy is released, diaphragm 241, 242 pushes back against end 631, 632 of fork 636 of actuation member 630. As actuation member 630 is moved back and forth around its pivot, ends 631, 632 of fork 636 of actuator 600 go through opposite strokes. While end 631 is in its actuation stroke, end 632 is in its recovery stroke, and vice versa. As a result of this arrangement, elastic recovery force imparted on actuation member 630 by the recovering side of diaphragm 240 is transferred to the side of diaphragm 240 being actuated, helping in actuation. The force required to actuate each side of the pump 201 is therefore reduced, thereby reducing the energy required to operate actuator 600.

Though the illustrated embodiment shows an actuator 600 that actuates left and right pump chambers 213, 214 of pump 201 in an alternating fashion, in some embodiments, an actuator (not shown) may actuate both pump chambers 213, 214 simultaneously. Direction of forces applied to actuate left and right pump chambers 213, 214 would be opposed. In some embodiments of pump 201 these forces may operate in the same direction, or in any other direction relative to each other.

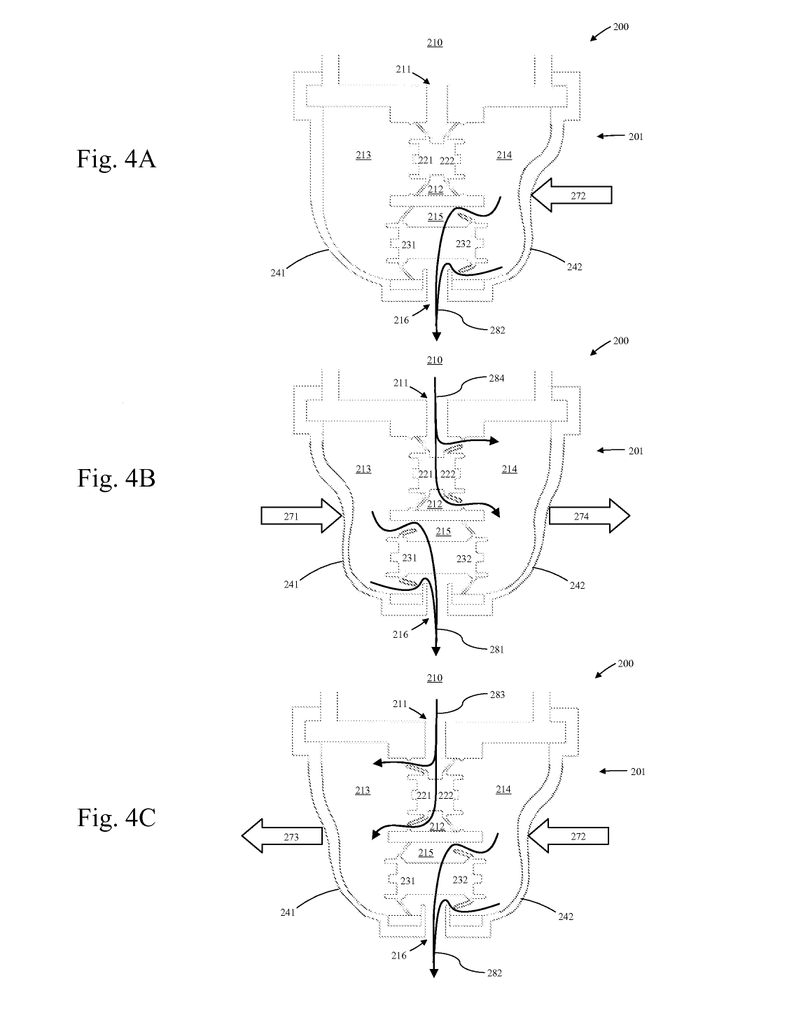

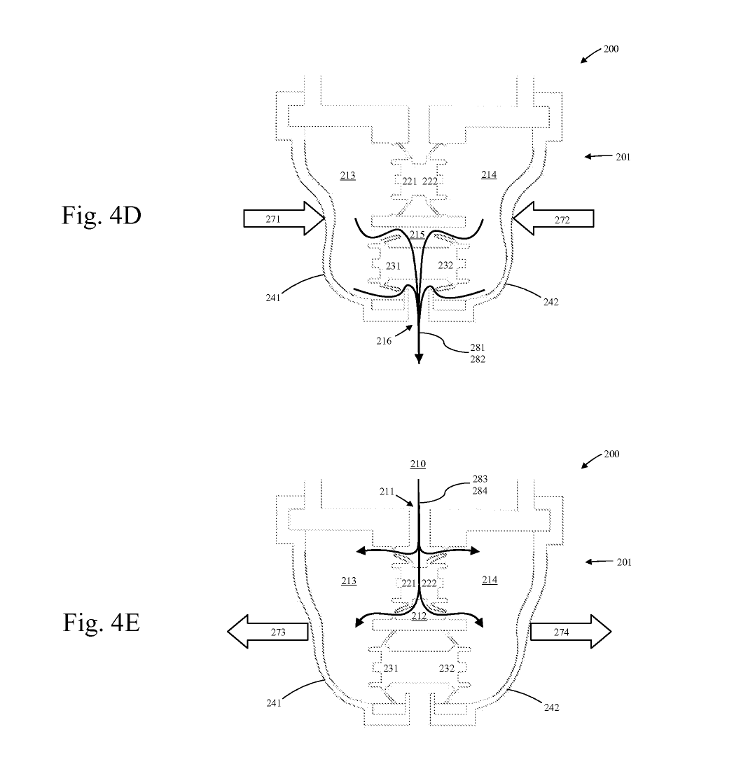

FIGS. 4A, 4B, and 4C illustrate alternating actuation of left and right pump chambers 213, 214 of pump 201. In FIG. 4A, actuation force 272 actuates right pump chamber 214, causing right outlet valve 232 to open and liquid to flow out of pump 201 following flow path 282. In FIG. 4B, actuation force 271 actuates left pump chamber 213, causing left outlet valve 231 to open and liquid to flow out of pump 201 following flow path 281. At the same time, actuation force 272 is removed from right pump chamber 214 and elastic recovery force 274 expands right pump chamber 214 to its original size, causing right inlet valve 222 to open and allow fluid to flow from reservoir 210 into right pump chamber 214 along flow path 284. FIG. 4C shows right pump chamber 214 being actuated again while left pump chamber 213 elastically recovers causing fluid to flow into left pump chamber 213 from reservoir 210 along flow path 283. Increasing the frequency of actuation of alternating chambers increase the volumetric flow rate of liquid pumped out of pump 201, while decreasing the frequency of alternating actuation cycles reduces the volumetric flow rate of liquid pumped out of pump 201.

FIGS. 4D and 4E illustrate simultaneous actuation of left and right pump chambers 213, 214 of pump 201. FIG. 4D illustrates actuation forces 271, 272 being applied to both pump chambers simultaneously, causing both outlet valves 231, 232 to open and fluid to flow out of pump 201 along flow paths 281, 282. When actuation forces 271, 272 are removed, as shown in FIG. 4E, left and right pump chambers 213, 214 are restored to their original size by elastic recovery forces 273, 274 causing left and right inlet valves 221, 222 to open and allow liquid to flow from reservoir 210 into both pump chambers along flow paths 283, 284. Simultaneous actuation of both pump chambers causes more volume of liquid to be dispensed in a single actuation cycle than when the pump chambers are actuated in an alternating fashion.

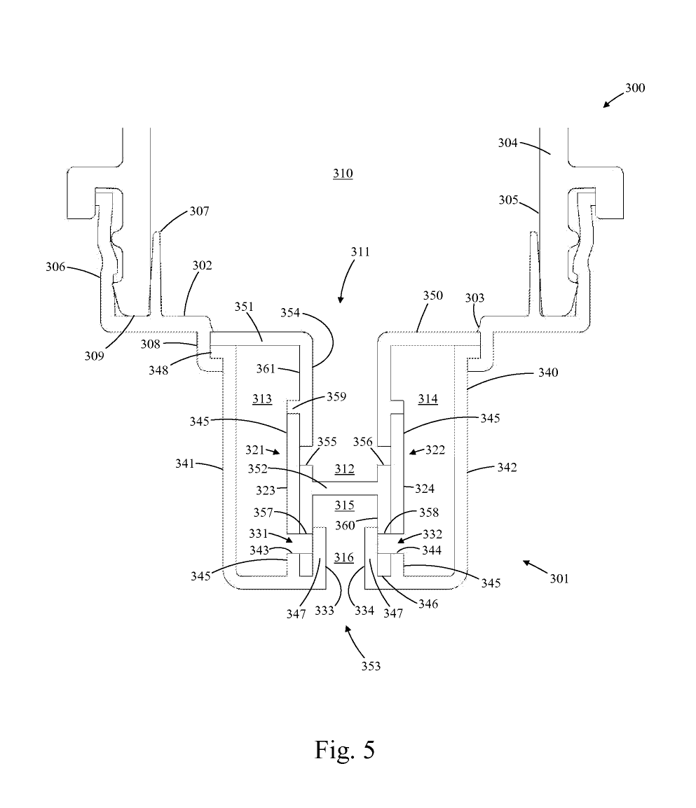

FIG. 5 is a cross-sectional view of another exemplary embodiment of a refill unit 300 suitable for use in liquid dispensers. Refill unit 300 includes a container 304 connected to a pump 301. The interior of the container 304 forms a reservoir 310 for holding dispensable liquid. Pump 301 includes a housing 302 with an outer wall 306 and annular projection 307. A neck 305 of container 304 is received within a groove 309 formed between outer wall 306 and annular projection 307. Housing 302 may be connected to container 304 by any means, such as a threaded connection, a welded connection, an adhesive connection, or the like. Optionally, a gasket may fit between neck 305 and housing 302 in groove 309 to help form a liquid tight seal with container 304.

Pump housing 302 further includes a valve body 350 that forms part of one-way inlet valves 321, 322 and two one-way outlet valves 331, 332. Valve body 350 includes an inlet plate 351 and a central bore 354. Bore 354 is in fluid communication with reservoir 310 and forms inlet passageway 311. Bore 354 is separated into inlet valve chamber 312 and outlet valve chamber 315 by divider 352. The outlet nozzle 353 of bore 354 is open to the environment, forming outlet passageway 316. Valve body 350 includes one or more left chamber inlet apertures 355, one or more right chamber inlet apertures 356, one or more left chamber outlet apertures 357, and one or more right chamber outlet apertures 358.

Pump 301 includes a diaphragm 340 that sealably connects with housing 302 and valve body 350 forming a left pump chamber 313 and a right pump chamber 314. Pump housing 302 includes a lip 308 that retains diaphragm 340 and inlet plate 351. Diaphragm 340 includes an annular projection 348 that engages the interior of lip 308. Valve body inlet plate 351 presses against the exposed side of annular projection 348 sealing annular projection 348 against pump housing lip 308. Inlet plate 351 is held in place against diaphragm 340 by ridge 303. Diaphragm 340 may be connected to valve body 350 and pump housing 302 by any means, such as with an adhesive connection, welded connection, or the like. Diaphragm 340 may be any elastomeric material, such as an elastomeric material having a Shore A hardness of between about 20-70 durometer, including, but not limited to, silicone, polyurethane, vinyl, TPE, TPV, TPR, or rubber.

Diaphragm 340 includes an annular projection 345 that extends upwards and forms sealing members 323, 324 of left and right inlet valves 321, 322. Annular projection 345 includes one or more apertures 343, 344 that align with the one or more outlet apertures 357, 358 described above. Diaphragm 340 also includes an inner annular projection 347 that extends upward and forms sealing members 333, 334 of left and right outlet valves 331, 332. Outlet nozzle 353 of central bore 354 is received into a groove 346 formed between inner and outer annular projections 345, 347 of diaphragm 340, creating a liquid tight seal between diaphragm 340 and valve body 350. An annular ridge 359 on the exterior of bore 354 forms stop 359 that, along with groove 346, helps to properly position diaphragm 340 and valve body 350 such that the valve sealing members 323, 324, 333, 334 are properly aligned.

Left inlet valve 321 is a one-way valve that is oriented such that it allows flow into, and prevents flow out of, left pump chamber 313 through left inlet valve aperture 355. Right inlet valve 322 is a one-way valve that is oriented such that it allows flow into, and prevents flow out of, right pump chamber 314 through right inlet valve aperture 356. Flexible sealing members 323, 324 are rigid enough to seal against the outer surface 361 of bore 354 when in a resting position, thereby preventing flow through left and right inlet valve apertures 355, 356 and maintaining inlet valves 321, 322 in a closed state. Flexible sealing members 323, 324 are flexible enough that they will bend inward, respectively, toward left and right pump chambers 313, 314 when the fluid pressure is lower in pump chambers 313, 314 than it is in inlet valve chamber 312, thereby allowing liquid to flow from inlet valve chamber 312 into the left or right pump chamber 313, 314.

Left outlet valve 331 is a one-way valve that is oriented such that it allows flow out of, and prevents flow into, left pump chamber 313 through left outlet valve apertures 343, 357. Right outlet valve 322 is a one-way valve that is oriented such that it allows flow out of, and prevents flow into, right pump chamber 314 through right outlet valve apertures 344, 358. Flexible sealing members 333, 334 are rigid enough to seal against the inner surface 360 of bore 354 when in a resting position, thereby preventing flow through left and right outlet valve apertures 343, 357, 344, 358 and maintaining outlet valves 331, 332 in a closed state. Flexible sealing members 333, 334 are flexible enough that they will bend inward toward outlet valve chamber 315 when the fluid pressure is higher in left and right pump chambers 313, 314 than it is in outlet valve chamber 315, thereby allowing liquid to flow from left or right pump chamber 313, 314 into outlet valve chamber 315.

Pump 301 is actuated by applying force to the left side 341 or right side 342 of diaphragm 340. Applying force to the left side 341 of diaphragm 340 actuates left pump chamber 313, and applying force to the right side 341 of diaphragm 340 actuates right pump chamber 314. In either case, the volume of pump chambers 313, 314 is reduced by application of force to diaphragm 340, moving diaphragm 340 from a charged or primed state to a discharged state. This reduction in volume causes the fluid inside the pump chambers 313, 314 to increase in pressure thereby causing outlet valves 331, 332 to open, releasing fluid from pump chambers 313, 314. When the actuating force is removed, left or right sides 341, 342 of diaphragm 340 return to their charged position. The volume of pump chambers 313, 314 increases as the diaphragm 340 elastically recovers, causing the pressure in pump chambers 313, 314 to drop. The dropping pressure in pump chambers 313, 314 causes outlet valves 331, 331 to close and inlet valves 321, 322 to open, allowing fluid to flow into pump chambers 313, 314, priming pump 301. Pump 301 may be actuated manually or by an actuator similar to actuator 600 illustrated in FIG. 3A.

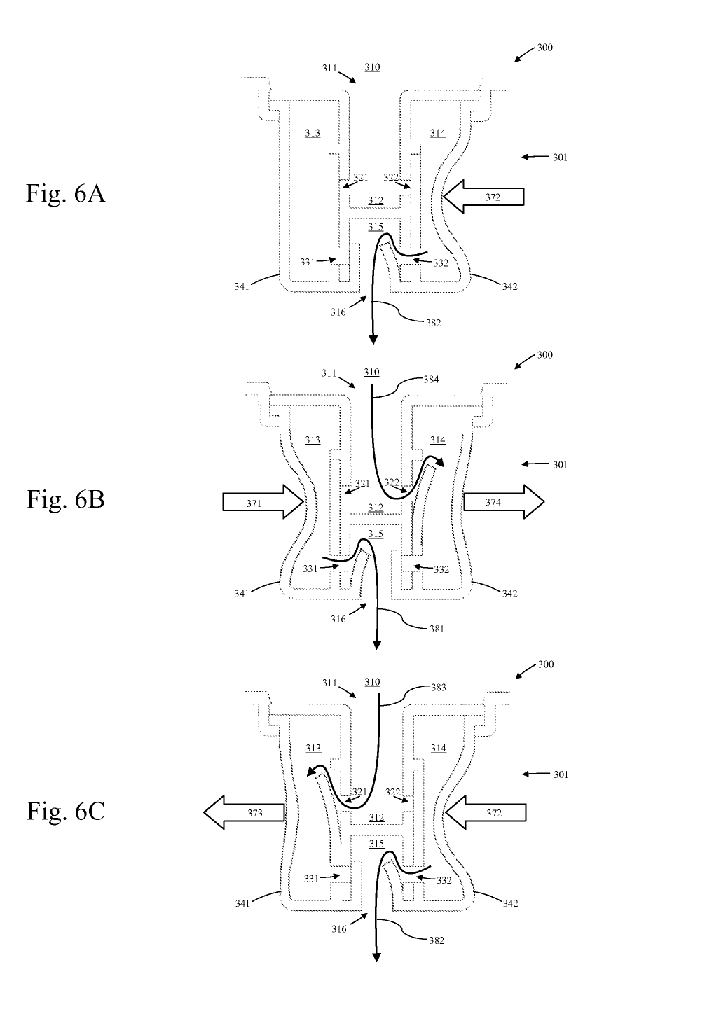

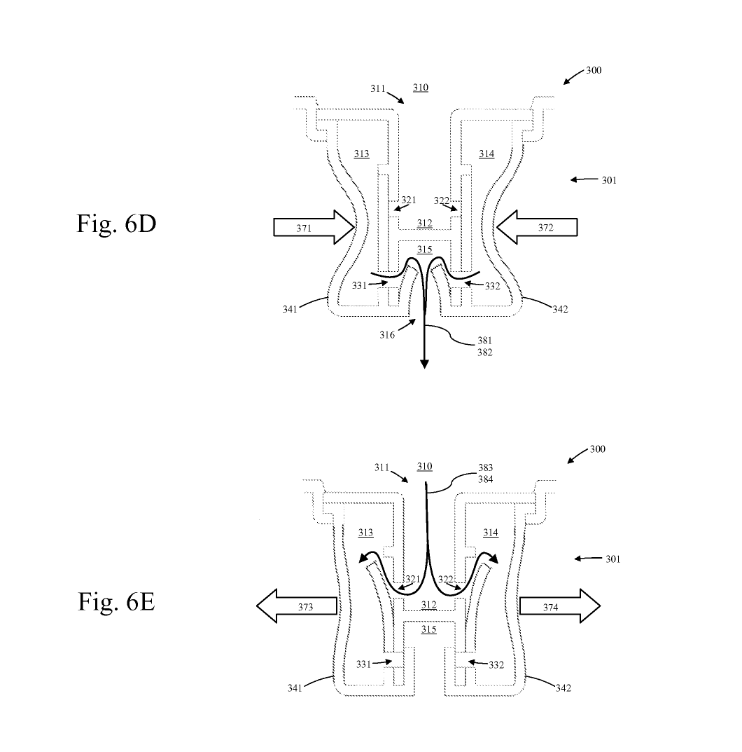

FIGS. 6A, 6B, and 6C illustrate alternating actuation of the left and right pump chambers 313, 314 of pump 301. In FIG. 6A, actuation force 372 actuates right pump chamber 314, causing right outlet valve 332 to open and liquid to flow out of pump 301 following flow path 382. In FIG. 6B, actuation force 371 actuates left pump chamber 313, causing left outlet valve 331 to open and liquid to flow out of pump 301 following flow path 381. At the same time, actuation force 372 is removed from right pump chamber 314 and elastic recovery force 374 expands right pump chamber 314 to its original size, causing right inlet valve 322 to open and allow fluid to flow from reservoir 310 into right pump chamber 314 along flow path 384. FIG. 6C shows right pump chamber 314 being actuated again while left pump chamber 313 elastically recovers causing fluid to flow into left pump chamber 313 from reservoir 310 along flow path 383. Increasing the frequency of actuation of alternating chambers increases the volumetric flow rate of liquid to be pumped out of pump 301, while decreasing the frequency of alternating actuation cycles reduces the volumetric flow rate of liquid pumped out of pump 301.

FIGS. 6D and 6E illustrate simultaneous actuation of the left and right pump chambers 313, 314 of pump 301. FIG. 6D illustrates actuation forces 371, 372 being applied to both pump chambers simultaneously, causing both outlet valves 331, 332 to open and fluid to flow out of pump 301 along flow paths 381, 382. When actuation forces 371, 372 are removed, as shown in FIG. 6E, left and right pump chambers 313, 314 are restored to their original size by elastic recovery forces 373, 374 causing left and right inlet valves 321, 322 to open and allow liquid to flow from reservoir 310 into both pump chambers along flow paths 383, 384. Simultaneous actuation of both pump chambers causes more volume of liquid to be dispensed in a single actuation cycle than when the pump chambers are actuated in an alternating fashion.

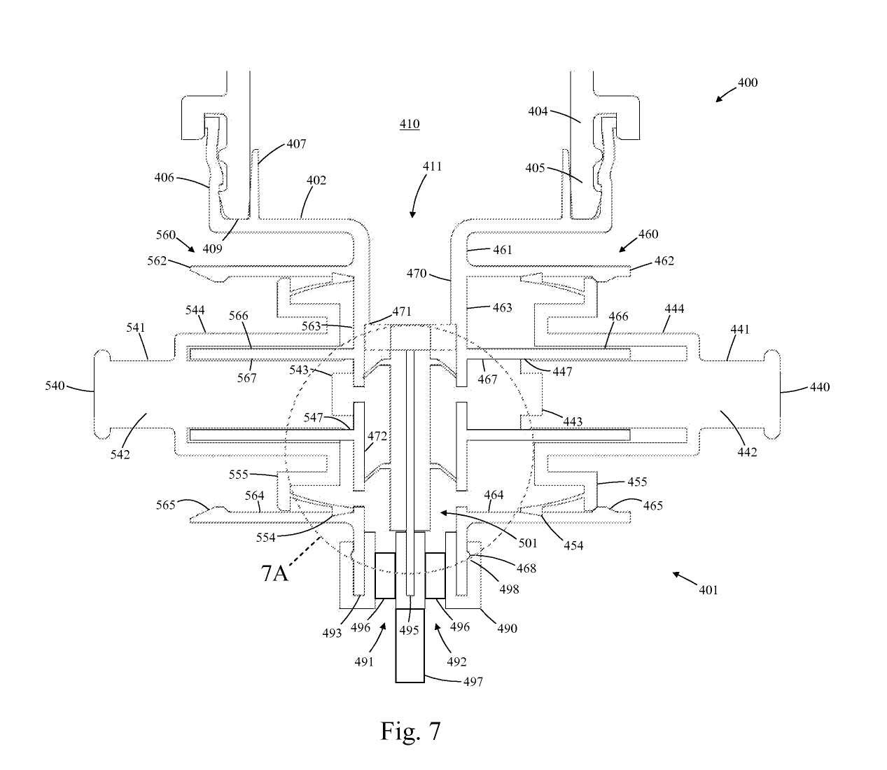

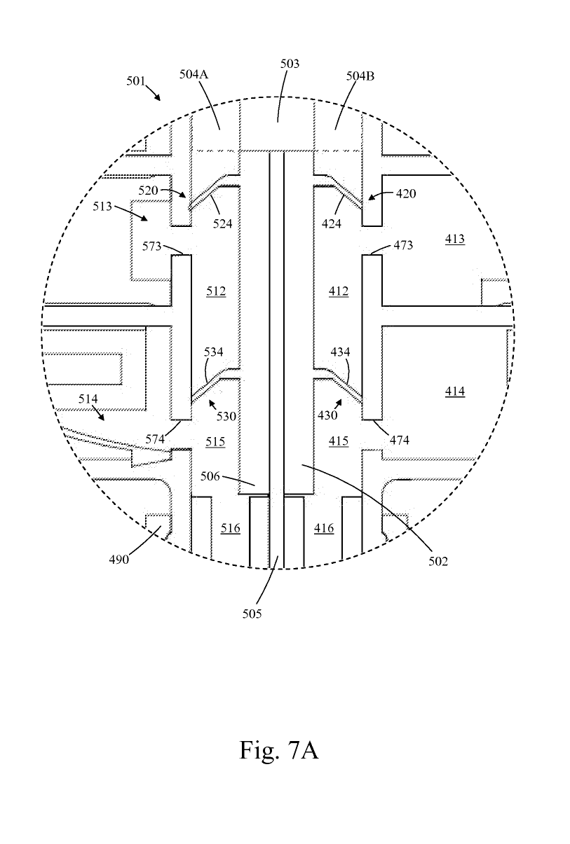

FIGS. 7 and 7A are cross-sectional views of another exemplary embodiment of a refill unit 400 suitable for use in liquid dispensers. The portion of FIG. 7 indicated by circle 7A is enlarged and shown in FIG. 7A to more clearly illustrate the interior of refill unit 400. Refill unit 400 includes a container 404 connected to a pump 401. The interior of container 404 forms a reservoir 410 for holding dispensable liquid. Pump 401 includes a housing 402 with an outer wall 406 and annular projection 407. A neck 405 of container 404 is received within a groove 409 formed between outer wall 406 and annular projection 407. Housing 402 may be connected to the container 404 by any means, such as a threaded connection, a welded connection, an adhesive connection, or the like. Optionally, a gasket may fit between neck 405 and housing 402 in groove 409 to help form a liquid tight seal with container 404.

Pump housing 402 further includes a valve housing 461 and left and right piston housings 560, 460 that project from valve housing 461. Valve housing 461 is an integral part of pump housing 402, but may be separate, and extends from pump housing 402 away from container 404. Valve housing 461 is connected to pump housing 402 by any means, such as with a threaded connection, an adhesive connection, welded connection, or the like. The interior surface 470 of valve housing 461 is in fluid communication with reservoir 410 and forms an inlet passageway 411. The inner diameter of valve housing 461 increases at step 471 to provide a sealing surface 472 for wiper valves 524, 424, 534, 434 of valve assembly 501 that is inserted into valve housing 461 and secured by nozzle 490.

Piston housings 560, 460 each include a base 563, 463, an outer wall 562, 462, and a central annular projection 566, 466. Pistons 540, 440 include a central shaft 541, 441 that has an actuation end 542, 442 and a piston head 543, 443. Piston heads 543, 443 of piston shafts 541, 441 are inserted into annular projections 566, 466 of piston housings 560, 460. Piston heads 543, 443 are flared outward to form a sealing surface 547, 447 that seals against interior surface 567, 467 of annular projections 566, 466. Actuation ends 542, 442 of pistons 540, 440 may be adapted to interface with an actuator by any means, such as with an annular ridge 546, 446, a pin and hole, a hinge, or the like.

Pistons 540, 440 further include extensions 544, 444 that project out from central shaft 566, 466 to contact outer walls 562, 462 of piston housings 560, 460. Piston extensions 544, 444 also include wiper seals 554, 454 that create an air tight seal against the interior surface 564, 464 of piston housing outer walls 562, 462. Wiper seals 554, 454 may be any type of sealing member, such as an o'ring, a double wiper seal, or the like. Pistons 540, 440 are slidable in a reciprocating manner within piston housings 560, 460. Piston housing outer walls 562, 462 include annular ridges 565, 465 that engage the back side 555, 455 of piston extensions 544, 444 to stop movement of pistons 540, 440 at the end of their stroke.

Valve assembly 501 includes a cylindrical body 502 (FIG. 7A), an inlet 503 with a first side opening 504A, a second side opening 504B, and a divider 505. Valve assembly 501 is inserted into valve housing 461 until the inlet 503 engages with step 471 (FIG. 7) on the inner surface of valve housing 461. Valve assembly 501 is secured in valve housing 461 by nozzle 490 that snaps onto the outlet end 493 of valve housing 461. Nozzle 490 may be secured to valve housing 461 by any means, such as a threaded connection, an adhesive connection, a welded connection, a snap fit connection, or the like. Valve assembly 501 further includes flexible sealing members 524, 434, 534, 434 that seal against sealing surface 472 of valve housing 461 to form left and right inlet valves 520, 420, and left and right outlet valves 530, 430. Valve assembly divider 505 seals against sealing surface 472 to divide valve housing 461 into left and right valve chambers 512, 412, left and right mixing chambers 515, 415, and left and right outlet passageways 516, 416.

Nozzle 490 includes left and right openings 491, 492 to dispense foam at the end of left and right outlet passageways 516, 416 that are in fluid communication with left and right mixing chambers 515, 415 and the environment. Nozzle 490 includes a center groove 495 that receives valve assembly divider 505 (FIG. 7A), and annular groove 493 that receives outlet end 493 of valve housing 461. Nozzle 490 is connected to valve housing 461 by a retention groove 498 in annular groove 493 that snaps onto annular ridge 469 on the exterior of valve housing 461 when nozzle 490 is assembled. Nozzle 490 also includes a nozzle divider 497 that protrudes from the bottom surface of the nozzle between left and right openings 491, 492. In some embodiments, a nozzle divider 497 is included to prevent an air pump from drawing into openings 491, 492 during operation. Nozzle 490 may be connected to valve housing 461 by any means, such as a threaded connection, a press fit connection, an adhesive connection, a welded connection, or the like. Foaming media 496, such as one or more screens, are disposed within left and right openings 491, 492 of nozzle 490. In some embodiments, foaming media screens 496 are replaced with porous members, sponges, baffles, or the like.

Left inlet valve 520 is a one-way valve that is oriented such that it allows flow into, and prevents flow out of, left valve chamber 512 through valve assembly inlet 503. Right inlet valve 420 is a one-way valve that is oriented such that it allows flow into, and prevents flow out of, right valve chamber 412 through valve assembly inlet 503. Flexible sealing members 524, 424 are wiper valves and are rigid enough to seal against valve housing sealing surface 472 in a resting position, thereby maintaining inlet valves 520, 420 in a closed state. Flexible sealing members 423, 424 are flexible enough that they will bend toward the left and right valve chambers 512, 412, respectively, when the fluid pressure is lower in valve chambers 512, 412 than it is in inlet passageway 411, thereby allowing liquid to flow from inlet passageway 411 and into left or right valve chambers 512, 412. In some embodiments, left and right inlet valves 520, 420 can be any kind of one-way valves, such as a ball and spring valves, poppet valves, flapper valves, umbrella valves, slit valves, mushroom valves, duck bill valves, or the like.

Left outlet valve 530 is a one-way valve that is oriented such that it allows flow out of, and prevents flow into, left valve chamber 512. Right outlet valve 430 is a one-way valve that is oriented such that it allows flow out of, and prevents flow into, right valve chamber 412. Flexible sealing members 534, 434 are wiper valves and are rigid enough to seal against sealing surface 472 of valve housing 461 when in a resting position, thereby maintaining outlet valves 530, 430 in a closed state. Flexible sealing members 534, 434 are flexible enough that they will bend toward left and right mixing chambers 515, 415 when the fluid pressure is higher in the left and right valve chambers 512, 412 than it is in mixing chambers 515, 415, thereby allowing liquid to flow from left and right valve chambers 512, 412 and into outlet mixing chambers 515, 415. In some embodiments, left and right outlet valves 530, 430 can be any kind of one-way valves, such as a ball and spring valves, poppet valves, flapper valves, umbrella valves, slit valves, mushroom valves, duck bill valves, or the like.

Liquid pump chambers 513, 413 are formed by piston housing bases 563, 463, central annular projections 566, 466, and piston heads 543, 443. Liquid pump chambers 513, 413 are in fluid communication with left and right valve chambers 512, 412 through apertures 573, 473. Air pump chambers 514, 414 are formed by piston housing bases 563, 463, central annular projections 566, 466, housing outer walls 562, 462, and piston extensions 544, 444. Movement of pistons 540, 440 causes the volume of liquid pump chambers 513, 413 and air pump chambers 514, 414 to expand and contract.

During operation, as each piston 540, 440 moves from a discharged position to a charged position or primed state, liquid flows from reservoir 410 through inlet passageway 411 past left and right inlet valves 520, 420 into left and right valve chambers 512, 412 and then into left and right liquid pump chambers 513. 413. Simultaneously, air is drawn into pump 401 through left and right outlet passageways 516, 416, through left and right mixing chambers 515, 415 and into air pump chambers 514, 414. When pistons 540, 440 are actuated by moving them to the discharged position from the charged position, liquid is forced out of liquid pump chambers 513, 413 through valve chambers 512, 412 past outlet valves 530, 430 and into mixing chambers 515, 415. Simultaneously, air is forced out of air pump chambers 514, 414 and into mixing chambers 515, 415 to mix with liquid and create foam. The air and liquid mixture, or foam, is then dispensed through foaming media 496 in outlet passageways 516, 416 in nozzle 490. When pump 401 is operated in an alternating fashion, for example, by moving left piston 540 to a discharged position while simultaneously moving right piston 440 to a charged position, nozzle divider 497 prevents foam dispensed from left outlet passageway 516 from being drawn into right outlet passageway 416 along with air being drawn into right air pump chamber 414 through right outlet passageway 416, and vice versa.

Pump 401 may be actuated manually or by an actuator similar to actuator 600 illustrated in FIG. 3A. The pistons 540, 440 of pump 401 may be actuated in an alternating fashion or simultaneously, similar to the pumps in exemplary refill units 200 and 300 discussed above. Pistons 540, 440 of pump 401 may be moved between their charged and discharged states by any means, such as by use of an electric actuator, mechanical actuator, springs or the like. Though pump 401 of refill unit 400 includes both liquid and air pump chambers, a refill unit embodying the principles of the present invention may be for pumping liquid only, or may include air and liquid chambers to create foam.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and illustrative examples shown and described. Accordingly, departures may be made from such details without departing from the spirit or scope of the applicants' general inventive concept.

We claim:

1. A refill unit comprising:
a container; and
a pump secured to the container;
the pump having
a liquid inlet;
a first chamber;
a second chamber;
a liquid inlet valve;
a liquid outlet valve; and
an outlet;
wherein the liquid inlet valve has a first sealing member that allows fluid to flow into the first chamber and a second sealing member that allows fluid to flow into the second chamber and prevents fluid from flowing out of the first chamber back into the container; and
wherein the liquid outlet valve has a first sealing member that allows fluid to flow out of the first chamber and through the liquid outlet and a second sealing member that allows fluid to flow out of the second chamber and through the liquid outlet.

2. The refill unit of claim 2 further comprising an elastomeric diaphragm that forms at least a portion of the first and second chambers.

3. The refill unit of claim 2 wherein the liquid inlet valve comprises a plurality of wiper seals.

4. The refill unit of claim 2 wherein the liquid outlet valve comprises a plurality of wiper seals.

5. The refill unit of claim 2 wherein the liquid inlet valve is parallel to the liquid outlet valve.

6. The refill unit of claim 2 wherein the liquid inlet valve is a unitary part.

7. The refill unit of claim 2 wherein the elastomeric diaphragm is resilient and when pressure is removed from the elastomeric diaphragm, the first and second chambers expand to draw fluid into the first and second chambers.

8. A refill unit for a dispenser comprising:
a container; and
a pump secured to the container;
the pump having a first pumping chamber;
a first liquid inlet valve to the first pump chamber;
a first liquid outlet valve from the first pump chamber;
a second pumping chamber;
a second liquid inlet valve to the second pump chamber;
a second liquid outlet valve from the second pump chamber; and
an outlet;
wherein the first pump chamber, the first liquid inlet valve, the first liquid outlet valve, the second pump chamber, the second liquid inlet valve; and the second liquid outlet valve are formed by a unitary elastomeric member.

9. The refill unit of claim 8 further comprising a central bore, wherein the central bore provides a seat for at least one of the first liquid inlet valve, first liquid outlet valve, second liquid inlet valve and the second liquid outlet valve.

10. A refill unit comprising:
a container;
a pump connected to the container;
the pump having a liquid inlet and a liquid outlet;
the pump having an elastomeric dome;
the elastomeric dome forming a first pump chamber and a second pump chamber located between the liquid inlet and the liquid outlet;
a liquid inlet valve having
a first liquid inlet sealing member for allowing fluid to flow from the liquid inlet to the first pump chamber when the first pump chamber has a negative pressure and prevents fluid from flowing from the first pump chamber into the liquid inlet when there is a positive pressure in the first pump chamber and
a second liquid inlet sealing member for allowing fluid to flow from the liquid inlet to the second pump chamber when the second pump chamber has a negative pressure and prevents fluid from flowing from the second pump chamber into the liquid inlet when there is a positive pressure in the second pump chamber.

11. The refill unit of claim 10 further comprising:
a liquid outlet valve having
a first liquid outlet sealing member for allowing fluid to flow out of the liquid outlet from the first pump chamber when the first pump chamber has a positive pressure and prevents fluid from flowing into the first pump chamber when there is a negative pressure in the first pump chamber; and
a second liquid outlet sealing member for allowing fluid to flow out of the liquid outlet from the second pump chamber when the second pump chamber has a positive pressure and prevents fluid from flowing into the second pump chamber when there is a negative pressure in the second pump chamber.

12. The refill unit of claim 10 wherein the liquid inlet valve is parallel to the liquid outlet valve.

13. The refill unit of claim 10 wherein the liquid inlet valve is a unitary part.

14. The refill unit of claim 10 wherein the liquid outlet valve is a unitary part.

15. A refill unit comprising:
a container;
a pump secured to the container;
the pump having;
a first pumping portion having a first liquid pump;
a second pump portion having a second liquid pump;
wherein the first pump portion is activated by applying a force in a first direction and the second pump portion is activated by applying force in a second direction that is different than the first direction.

16. The refill unit of claim 15 further comprising a first air pump and a second air pump.

17. The refill unit of claim 15 wherein the first direction and the second direction are substantially opposite directions.

18. The refill unit of claim 16 wherein the first liquid pump and first air pump comprise pistons.

19. The refill unit of claim 18 wherein the second liquid pump and second air pump comprise pistons.

20. The refill unit of claim 15 wherein the pump is configured so that when the first pump portion is priming the second pump portion is dispensing and wherein when the second pump portion is priming the first pump portion is dispensing.
